(19) United States
(12) Patent Application Publication
(10) Pub. No.: US 2023/0156401 A1
(43) Pub. Date: May 18, 2023

(54) Systems and Methods for Generating Audio Presentations

(71) Applicants: Robert MARCHANT, London (GB); David Matthew JONES, London (GB); Philip ROADLEY-BATTIN, Mountain View, CA (US); Amelia SCHLADOW, Mountain View, CA (US); Henry John HOLLAND, London (GB); Google LLC, Mountain View, CA (US)

(72) Inventors: Robert Marchant, Richmond (GB); David Matthew Jones, London (GB); Phillip Roadley-Battin, Oakland, CA (US); Amelia Schladow, San Francisco, CA (US); Henry John Holland, London (GB)

(21) Appl. No.: 17/919,931

(22) PCT Filed: Apr. 22, 2020
(86) PCT No.: PCT/US2020/029304

§ 371 Date: Oct. 19, 2022

(51) Int. Cl. H04R 3/00; H04R 1/10; G10K 11/178

(52) U.S. Cl. CPC H04R 3/005; H04R 1/1041; G10K 11/17823; H04R 2460/07

(57) ABSTRACT

Systems and methods for generating audio presentations are provided. A method can include obtaining data indicative of an acoustic environment for a user; obtaining data indicative of one or more events; generating, by an artificial intelligence system, an audio presentation for the user based at least in part on the data indicative of the one or more events and the data indicative of the acoustic environment for the user; and presenting the audio presentation to the user. The acoustic environment can include at least one of a first audio signal playing on the computing system or a second audio signal associated with a surrounding environment of the user. The one or more events can include at least one of information to be conveyed by the computing system to the user or at least a portion of the second audio signal associated with the surrounding environment of the user.

### FIELD

The present disclosure relates generally to systems and methods for generating audio presentations. More particularly, the present disclosure relates to devices, systems, and methods that leverage an artificial intelligence system to incorporate audio signals associated with events into an acoustic environment of a user at particular times.

### BACKGROUND

Personal computing devices, such as smartphones, have provided the ability to listen to audio based content on demand and across a wide variety of platforms and applications. For example, a person can listen to music and movies stored locally on their smartphones; stream movies, music, television shows, podcasts, and other content from a multitude of complimentary and subscription-based services; access multimedia content available on the internet; etc. Additionally, advances in wireless speaker technology have allowed for users to listen to such audio content in a variety of environments.

However, in a typical implementation, a user only has a binary choice about whether audio information is presented to the user. For example, while listening to audio content in a noise-canceling mode, all external signals may be cancelled, including audio information the user would prefer to hear. Additionally, when a user receives any type of notification, message, prompt, etc. on the user's phone, audio information associated with these events will typically be presented upon receipt, often interrupting any other audio content playing for the user.

### SUMMARY

Aspects and advantages of the present disclosure will be set forth in part in the following description, or may be obvious from the description, or may be learned through practice of embodiments of the present disclosure.

One example aspect of the present disclosure is directed to a method for generating an audio presentation for a user. The method can include obtaining, by a portable user device comprising one or more processors, data indicative of an acoustic environment of the user. The acoustic environment of the user can include at least one of a first audio signal playing on the portable user device or a second audio signal associated with a surrounding environment of a user that is detected via one or more microphones that form part of, or are communicatively coupled with, the portable user device. The method can further include obtaining, by the portable user device, data indicative of one or more events. The one or more events can include at least one of information to be conveyed by the portable user device to the user or at least a portion of the second audio signal associated with the surrounding environment of the user. The method can further include generating, by an on-device artificial intelligence system of the portable user device, an audio presentation for the user based at least in part on the data indicative of the one or more events and the data indicative of the acoustic environment of the user. Generating the audio presentation can include determining a particular time to incorporate a third audio signal associated with the one or more events into the acoustic environment. The method can further include presenting, by portable user device, the audio presentation to the user.

Another example aspect of the present disclosure is directed to a method for generating an audio presentation for a user. The method can include obtaining, by a computing system comprising one or more processors, data indicative of an acoustic environment for the user. The acoustic environment for the user can include at least one of a first audio signal playing on the computing system or a second audio signal associated with a surrounding environment of a user. The method can further include obtaining, by the computing system, data indicative of one or more events. The one or more events can include at least one of information to be conveyed by the computing system to the user or at least a portion of the second audio signal associated with the surrounding environment of the user. The method can further include generating, by an artificial intelligence system via the computing system, an audio presentation for the user based at least in part on the data indicative of the one or more events and the data indicative of the acoustic environment for the user. The method can further include presenting, by the computing system, the audio presentation to the user. Generating, by the artificial intelligence system, the audio presentation can include determining, by the artificial intelligence system, a particular time to incorporate a third audio signal associated with the one or more events into the acoustic environment.

Another example aspect of the present disclosure is directed to a method of training an artificial intelligence system. The artificial intelligence system can include one or more machine-learned models. The artificial intelligence system can be configured to generate an audio presentation for a user by receiving data of one or more events and incorporating a first audio signal associated with the one or more events into an acoustic environment of the user. The method can include obtaining, by a computing system comprising one or more processors, data indicative of one or more previous events associated with a user. The data indicative of the one or more previous events can include semantic content for the one or more previous events. The method can further include obtaining, by the computing system, data indicative of a user response to the one or more previous events. The data indicative of the user response can include at least one of one or more previous user interactions with the computing system in response to the one or more previous events or one or more previous user inputs descriptive of an intervention preference received in response to the one or more previous events. The method can further include training, by the computing system, the artificial intelligence system comprising the one or more machine-learned models to incorporate an audio signal associated with one or more future events into an acoustic environment of the user based at least in part on the semantic content for the one or more previous events associated with the user and the data indicative of the user response to the one or more events. The artificial intelligence system can be a local artificial intelligence system associated with the user.

Other aspects of the present disclosure are directed to various systems, apparatuses, non-transitory computer-readable media, machine-readable instructions, and electronic devices.

These and other features, aspects, and advantages of the present disclosure will become better understood with reference to the following description and appended claims. The accompanying drawings, which are incorporated in and constitute a part of this specification, illustrate embodiments of the present disclosure and, together with the description, serve to explain the principles of the present disclosure.

### BRIEF DESCRIPTION OF THE DRAWINGS

A full and enabling description of the present disclosure, directed to one of ordinary skill in the art, is set forth in the specification, which makes reference to the appended figures, in which:

FIG. 1A depicts a block diagram of an example system that generates an audio presentation for a user via an artificial intelligence system according to example aspects of the present disclosure;

FIG. 1B depicts a block diagram of an example computing device according to example aspects of the present disclosure;

FIG. 1C depicts a block diagram of an example computing device according to example aspects of the present disclosure;

FIG. 2A depicts a block diagram of an example artificial intelligence system according to example aspects of the present disclosure;

FIG. 2B depicts a block diagram of an example artificial intelligence system according to example aspects of the present disclosure;

FIG. 2C depicts a block diagram of an example artificial intelligence system according to example aspects of the present disclosure;

FIG. 2D depicts a block diagram of an example artificial intelligence system according to example aspects of the present disclosure;

FIG. 2E depicts a block diagram of an example artificial intelligence system according to example aspects of the present disclosure;

FIG. 2F depicts a block diagram of an example artificial intelligence system according to example aspects of the present disclosure;

FIG. 3 depicts a graphical representation of an acoustic environment for a user according to example aspects of the present disclosure;

FIG. 4A depicts a graphical representation of a plurality of events comprising a communication according to example aspects of the present disclosure;

FIG. 4B depicts a graphical representation of an example summary of a plurality of events according to example aspects of the present disclosure;

FIG. 5 depicts a graphical representation of an example barge intervention tactic according to example aspects of the present disclosure;

FIG. 6A depicts a graphical representation of an example slip intervention tactic according to example aspects of the present disclosure;

FIG. 6B depicts a graphical representation of an example slip intervention tactic according to example aspects of the present disclosure;

FIG. 7 depicts a graphical representation of an example filter intervention tactic according to example aspects of the present disclosure;

FIG. 8A depicts a graphical representation of an example stretch intervention tactic according to example aspects of the present disclosure;

FIG. 8B depicts a graphical representation of an example stretch intervention tactic according to example aspects of the present disclosure;

FIG. 9A depicts a graphical representation of an example loop intervention tactic according to example aspects of the present disclosure;

FIG. 9B depicts a graphical representation of an example loop intervention tactic according to example aspects of the present disclosure;

FIG. 9C depicts a graphical representation of an example loop intervention tactic according to example aspects of the present disclosure;

FIG. 9D depicts a graphical representation of an example loop intervention tactic according to example aspects of the present disclosure;

FIG. 10 depicts a graphical representation of an example move intervention tactic according to example aspects of the present disclosure;

FIG. 11 depicts a graphical representation of an example overlay intervention tactic according to example aspects of the present disclosure;

FIG. 12A depicts a graphical representation of an example duck intervention tactic according to example aspects of the present disclosure;

FIG. 12B depicts a graphical representation of an example duck intervention tactic according to example aspects of the present disclosure;

FIG. 13 depicts a graphical representation of an example glitch intervention tactic according to example aspects of the present disclosure;

FIG. 14 depicts an example method for generating an audio presentation according to example aspects of the present disclosure;

FIG. 15 depicts an example method for generating an audio presentation according to example aspects of the present disclosure; and

FIG. 16 depicts an example training method according to example aspects of the present disclosure.

### DETAILED DESCRIPTION

Generally, the present disclosure is directed to devices, systems, and methods which can generate an audio presentation for a user. For example, a computing device, such as a portable user device (e.g., a smartphone, wearable device, etc.) can obtain data indicative of an acoustic environment of a user. In some implementations, the acoustic environment can include a first audio signal playing on the computing device and/or a second audio signal associated with a surrounding environment of the user. The second audio signal can be detected via one or more microphones of the computing device. The computing device can further obtain data indicative of one or more events. The one or more events can include information to be conveyed by the computing system to the user and/or at least a portion of the second audio signal associated with the surrounding environment. For example, in various implementations, the one or more events can include communications received by the computing device (e.g., text messages, SMS messages, voice messages, etc.), audio signals from the surrounding environment (e.g., announcements over a PA system), notifications from an application operating on the computing device (e.g., application badges, news updates, etc.), or prompts from an application operating on the computing device (e.g., turn-by-turn directions from a navigation application). The computing system can then generate an audio presentation for the user based at least in part on the data indicative of the one or more events and the data indicative of the acoustic environment using an artificial intelligence (“AI”) system, such as an on-device AI system. For example, the AI system can use one or more machine-learned models to generate the audio presentation. The computing system can then present the audio presentation to the user. For example, in some implementations, the computing system can play the audio presentation for the user on a wearable speaker device (e.g., earbuds).

More particularly, the systems and methods of the present disclosure can allow for a user to be provided information audibly as a part of an immersive audio user interface, much as a graphical user interface visually provides information to users. For example, advances in computing technology have allowed for users to be increasingly connected over a variety of computing devices, such as personal user devices (e.g., smartphones, tablets, laptop computers, etc.) and wearable devices (e.g., smartwatches, earbuds, smartglasses, etc.). Such computing devices have allowed for information to be provided to users in real-time or near real-time. For example, applications operating on the computing devices can allow for real-time and near real-time communication (e.g., phone calls, text/SMS messages, video conferencing), notifications can quickly inform users of accessible information (e.g., email badges, social media posts updates, news updates, etc.), and prompts can provide real-time instructions for the user (e.g., turn-by turn directions, calendar reminders, etc.). However, in a typical implementation, a user may only have a binary option about whether such information is provided to the user (e.g., all or nothing).

Moreover, while advances in wireless sound technology have allowed for users to listen to audio content in a variety of environments, such as while wearing a wearable speaker device (e.g., a pair of earbuds), whether audio information is presented to the user is also typically a binary decision. For example, a user receiving one or more text messages will typically hear an associated sound for every message received or none at all. Additionally, sounds associated with the text messages are typically provided upon receipt, often interrupting any audio content playing for the user. Similarly, when a user is listening to audio content in a noise-cancelling mode, typically all external noises are cancelled. Thus, some audio information that a user may desire to hear (e.g., announcements over a PA system about a user's upcoming flight or another person speaking to the user) may be cancelled and thus never conveyed to the user. Thus, in order for a user to interact with the user's surrounding environment, the user may have to cease playing audio content or, in some situations, remove a wearable speaker device completely.

The devices, systems, and methods of the present disclosure, however, can intelligently curate audio information for a user and present the audio information to the user at an appropriate time. For example, a computing system, such as a portable user device, can obtain data indicative of an acoustic environment for the user. For example, the acoustic environment can include audio signals playing on the computing system (e.g., music, podcasts, audiobooks, etc.). The acoustic environment can also include audio signals associated with the surrounding environment of the user. For example, one or more microphones of a portable user device can detect audio signals in the surrounding environment. In some implementations, one or more microphones can be incorporated into a wearable audio device, such as a pair of wireless earbuds.

The computing system can also obtain data indicative of one or more events. For example, the data indicative of one or more events can include information to be conveyed by the computing system to the user and/or audio signals associated with the surrounding environment of the user. For example, in some implementations, the one or more events can include communications to the user received by the computing system (e.g., text messages, SMS messages, voice messages, etc.). In some implementations, the one or more events can include external audio signals received by the computing system, such as audio signals associated with the surrounding environment (e.g., PA announcements, verbal communications, etc.). In some implementations, the one or more events can include notifications from applications operating on the computing system (e.g., application badges, news updates, social media updates, etc.). In some implementations, the one or more events can include prompts from an application operating on the computing system (e.g., calendar reminders, navigation prompts, phone rings, etc.).

The data indicative of the one or more events and the data indicative of the acoustic environment can then be input into an AI system, such as an AI system stored locally on the computing system. For example, the AI system can include one or more machine-learned models (e.g., neural networks, etc.). The AI system can generate an audio presentation for the user based at least in part on the data indicative of the one or more events and the data indicative of the acoustic environment. Generating the audio presentation can include determining a particular time to incorporate an audio signal associated with the one or more events into the acoustic environment.

The computing system can then present the audio presentation to the user. For example, in some implementations, the computing system can be communicatively coupled with an associated peripheral device. The associated peripheral device can be, for example, a speaker device, such as an earbud device coupled to the computing system via Bluetooth or other wireless connection. In some implementations, the associated peripheral device, such as a speaker device (e.g., a wearable earbud device) can also be configured to play an audio presentation for the user. For example, a computing device of a computing system can be operable to communicate audio signals to the speaker device, such as via a Bluetooth connection, and upon receiving the audio signal, the speaker device can audibly play the audio presentation for the user.

In some implementations, the AI system can determine the particular time to incorporate the audio signal associated with the one or more events into the acoustic environment by identifying a lull (e.g., a gap) in the acoustic environment. For example, the lull can be a portion of the acoustic environment corresponding to a relatively quiet period as compared to the other portions of the acoustic environment. For example, for a user listening to a streaming music playlist, a lull may correspond to a transition period between consecutive songs. Similarly, for a user listening to an audiobook, a lull may correspond to a period between chapters. For a user on a telephone call, a lull may correspond to a time period after the user hangs up. For a user having a conversation with another person, a lull may correspond to a break in the conversation.

In some implementations, the lull can be identified prior to audio content being played for the user. For example, playlists, audiobooks, and other audio content can be analyzed and lulls can be identified, such as by a server computing device remote from the user's computing device. Data indicative of the lulls can be stored and provided to the user's computing device by the server computing system.

In some implementations, the lull can be identified in real-time or near real-time. For example, one or more machine-learned models can analyze audio content playing on the user's computing device and can analyze an upcoming portion of the audio content (e.g., a 15 second window of upcoming audio content to be played in the near future). Similarly, one or more machine-learned models can analyze audio signals in the acoustic environment to identify lulls in real-time or near real-time. In some implementations, the AI system can select a lull as the particular time to incorporate an audio signal associated with the one or more events into the acoustic environment.

In some implementations, the AI system can determine an urgency of the one or more events based at least in part on at least one of a geographic location of the user, a source associated with the one or more events, or a semantic content of the data indicative of the one or more events. For example, a notification about a changed location of a meeting may be more urgent when the user is driving to the meeting than when the user has not yet left for the meeting. Similarly, a user may not want to be provided certain information (e.g., text messages, etc.) when the user is working (e.g., at the user's place of employment) whereas the user may want to receive such information when the user is at home. The AI system can use one or more machine-learned models to analyze a geographic location of the user and determine an urgency of the one or more events based on the geographic location.

Likewise, the source associated with an event can be used to determine the urgency of the one or more events. For example, communications from the user's spouse is likely to be more urgent than a notification from a news application. Similarly, an announcement over a PA system about a departing flight may be more urgent than a radio advertisement playing in the user's acoustic environment. The AI system can use one or more machine-learned models to determine a source associated with the one or more events and determine an urgency of the one or more events based on the source.

The semantic content of the one or more events can also be used to determine an urgency of the one or more events. For example, a text message from a user's spouse that their child is sick at school is likely to be more urgent than a text message from the user's spouse requesting the user to pick up a gallon of milk on the way home. Similarly, a notification from a security system application operating on the phone indicating that a potential break-in is occurring is likely to be more urgent than a notification from the application that a battery in a security panel is running low. The AI system can use one or more machine-learned models to analyze the semantic content of the one or more events and determine an urgency of the one or more events based on the semantic content.

Further, in some implementations, the AI system can summarize the semantic content of the one or more events. For example, the user may receive a plurality of group text messages wherein the group is deciding whether and where to go to lunch. In some implementations, the AI system can use a machine-learned model to analyze the semantic content of the plurality of text messages and generate a summary of the text messages. For example, the summary can include the location and the time that the group chose for the group lunch.

Similarly, in some implementations, a single event can be summarized. For example, a user may be at an airport awaiting boarding for the user's flight. A boarding announcement for the flight may come over the PA system, and may include information such as a destination, flight number, departure time, and/or other information. The AI system can generate a summary for the user, such as “your flight is boarding now.”

In some implementations, the AI system can generate an audio signal based at least in part on the one or more events and incorporate the audio signal into the acoustic environment of the user. For example, in some implementations, a text-to-speech (TTS) machine-learned model can convert text information to an audio signal and can incorporate the audio signal into the acoustic environment of the user. For example, a summary of one or more events can be played for a user during a lull in the acoustic environment (e.g., at the end of a song).

In some implementations, the AI system can determine to not incorporate an audio signal associated with an event into the acoustic environment. For example, the AI system may incorporate a highly urgent event into the acoustic environment, while disregarding (e.g., not incorporating) a non-urgent event.

In some implementations, the AI system can generate the audio presentation by canceling at least a portion of an audio signal associated with the surrounding environment of the user. For example, a user may be listening to music in a noise-canceling mode. The AI system can obtain audio signals from the user's surrounding environment, which may include ambient or background noises (e.g., cars driving and honking, neighboring conversations, the din in a restaurant, etc.) as well as discrete audio signals, such as announcements over a PA system. In some implementations, the AI system can cancel the portion of the audio signal corresponding to the ambient noises while playing the music for the user. Further, the AI system can generate an audio signal associated with a PA announcement (e.g., a summary), and can incorporate the audio signal into the acoustic environment, as described herein.

In some implementations, the AI system can incorporate an audio signal associated with one or more events into an acoustic environment using one or more intervention tactics. For example, the intervention tactics can be used to incorporate the audio signal associated with the one or more events at the particular time.

As an example, some audio signals associated with the one or more events may be more urgent than others, such as highly urgent text messages or navigational prompts for a user to turn at a particular time. In such a situation, the AI system may incorporate an audio signal associated with the one or more events into the acoustic environment as soon as possible. For example, the AI system may use a “barge” intervention tactic in which an audio signal playing for the user on the computing system is interrupted to make room for the audio signal associated with the one or more events.

However, other intervention tactics can be used to present audio information to the user in a less invasive manner. For example, in some implementations, a “filter” intervention tactic can be used in which an audio signal playing for the user is filtered (e.g., only certain frequencies of the audio signal are played) while the audio signal associated with the one or more events is played. A “stretch” intervention tactic can hold and repeatedly play a portion of an audio signal playing on the computing system (e.g., holding a note of a song) while the audio signal associated with the one more events is played. A “loop” intervention tactic can select a portion of an audio signal playing on the computing system and repeatedly playing the portion (e.g., looping a 3 second slice of audio) while the audio signal associated with one or more events is played. A “move” intervention tactic can change a perceived direction of an audio signal playing on the computing system (e.g., left to right, front to back, etc.) while the audio signal associated with the one more events is played. An “overlay” intervention tactic can overlay an audio signal associated with the one or more events on an audio signal playing on the computing system (e.g., at the same time). A “duck” intervention tactic can reduce a volume of an audio signal playing on the computing system (e.g., making the first audio signal quieter) while playing the audio signal associated with the one or more events. A “glitch” intervention tactic can be used to generate a flaw in an audio signal playing on the computing system. For example, the glitch intervention tactic can be used to provide contextual information to the user, such as notifying a user when to turn (e.g., in response to a navigation prompt) or ticking off distance markers while the user is on a run (e.g., every mile). The intervention tactics described herein can be used to incorporate the audio signal associated with the one or more events into the user's acoustic environment.

In some implementations, the AI system can generate the audio presentation based at least in part on a user input descriptive of a listening environment. For example, the user may select a particular listening environment from a variety of listening environments, and the particular listening environment can be descriptive of whether more or less audio information associated with the one or more events should be conveyed to the user.

In some implementations, the AI system can be trained based at least in part on a previous user input descriptive of an intervention preference. For example, a training dataset can be generated by receiving one or more user inputs in response to one or more events. As an example, when a user receives a text message, the AI system can ask the user (e.g., via a graphical or audio user interface) whether the user would like to be notified of similar text messages in the future. The AI system can use, for example, the sender of the text message, the location of the user, the semantic content of the text message, the user's selected listening environment preference, etc. to train the AI system whether and/or when to present audio information associated with similar events occurring at a future time to the user.

In some implementations, the AI system can be trained based at least in part on one or more previous user interactions with the computing system in response to one or more of previous events. For example, additionally or alternatively to specifically requesting user input about the one or more events, the AI system can generate a training dataset based at least in part on whether and/or how the user responds to one or more events. As an example, a user responding to a text message quickly can indicate that similar text messages should have a higher urgency level than text messages which are dismissed, not responded to, or not responded to for an extended period of time.

The training dataset generated by the AI system can be used to train the AI system. For example, the one or more machine learned models of the AI system can be trained to respond to an event as a user has previously responded or as a user has indicated as a preferred response. The training dataset can be used to train a local AI system stored on the user's computing device.

In some implementations, the AI system can generate one or more anonymized parameters based on the local AI system and can provide the anonymized parameters to a server computing system. For example, the server computing system can use a federated learning approach to train a global model using a plurality of anonymized parameters received from a plurality of users. The global model can be provided to individual users and can be used, for example, to initialize the AI system.

The systems and methods of the present disclosure can provide a number of technical effects and benefits. For example, various implementations of the disclosed technology may improve the efficiency of conveyance of audio information to the user. For instance, certain implementations may allow more information to be provided to the user, without extending the overall duration for which audio information is conveyed to the user.

In addition or alternatively, certain implementations may reduce unnecessary user distraction, thereby enhancing the safety for a user. For example, the devices, systems, and methods of the present disclosure can allow for audio information to be conveyed to a user concurrently with the user performing other tasks, such as driving, etc. Moreover, in some implementations, audio information for a user can be filtered, summarized, and intelligently conveyed at an opportune time for the user based on a content and/or context of the audio information. This can increase the efficiency of conveying such information to the user as well as improving an experience of the user.

Various implementations of the devices, systems, and methods of the present disclosure may enable the wearing of head-mounted speaker devices (e.g., earbuds) without impairing the user's ability to operate effectively in the real world. For instance, important announcements in the real world may be conveyed to the user at an appropriate time such that the user's ability to effectively consume audio via the head-mounted speaker devices is not adversely affected.

The systems and methods of the present disclosure also provide improvements to computing technology. In particular, a computing device, such as a personal user device, can obtain data indicative of an acoustic environment of the user. The computing device can further obtain data indicative of one or more events. The computing device can generate an audio presentation for the user based at least in part on the data indicative of the one or more events and the data indicative of the acoustic environment of the user by an on-device AI system. The computing device can then present the audio presentation to the user, such as via one or more wearable speaker devices.

With reference now to the FIGS., example embodiments of the present disclosure will be discussed in further detail.

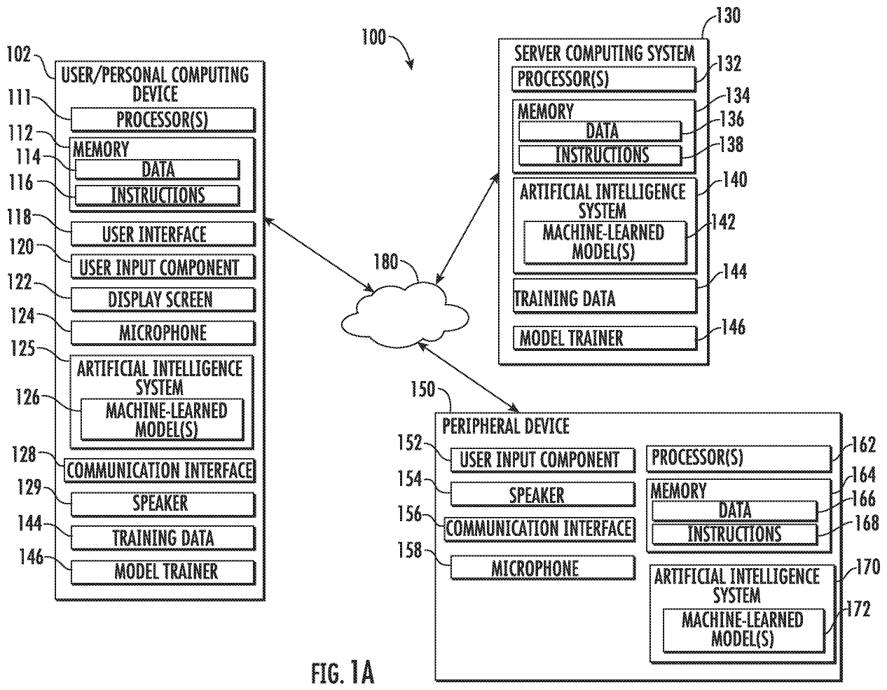

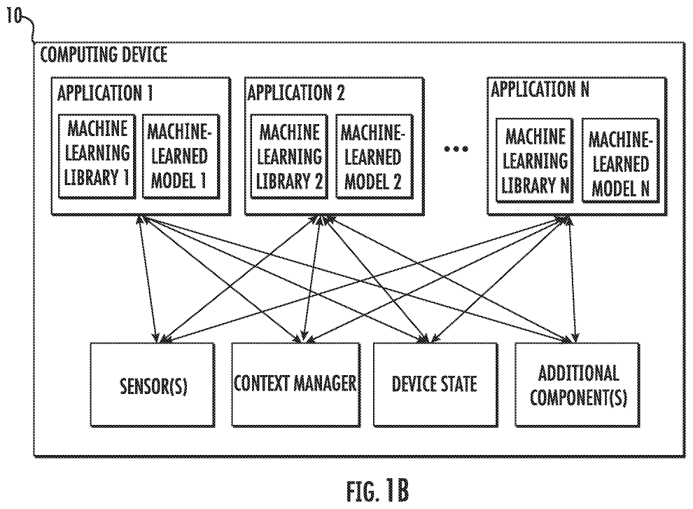

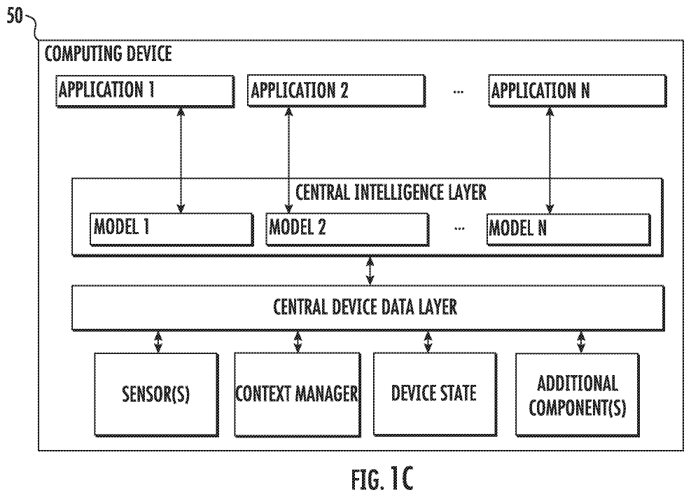

FIG. 1 depicts an example system for generating an audio presentation for a user according to example aspects of the present disclosure. The system 100 can include a computing device 102 (e.g., a user/personal/mobile computing device such as a smartphone), a server computing system 130, and a peripheral device 150 (e.g., a speaker device). In some implementations, the computing device 102 can be a wearable computing device (e.g., smartwatch, earbud headphones, etc.). In some implementations, the peripheral device 150 can be a wearable device (e.g., earbud headphones).

The computing device 102 can include one or more processors 111 and a memory 112. The one or more processors 111 can be any suitable processing device (e.g., a processor core, a microprocessor, an ASIC, a FPGA, a controller, a microcontroller, etc.) and can be one processor or a plurality of processors that are operatively connected. The memory 112 can include one or more non-transitory computer-readable storage mediums, such as RAM, ROM, EEPROM, EPROM, flash memory devices, magnetic disks, etc., and combinations thereof. In some implementations, the memory can include temporary memory, such as an audio buffer, for temporary storage of audio signals. The memory 112 can store data 114 and instructions 116 which can be executed by the processor 111 to cause the user computing device 102 to perform operations.

The computing device 102 can include one or more user interfaces 118. The user interfaces 118 can be used by a user to interact with the user computing device 102, such as to provide user input, such as selecting a listening environment, responding to one or more events, etc.

The computing device 102 can also include one or more user input components 120 that receive user input. For example, the user input components 120 can be a touch-sensitive component (e.g., a touch-sensitive display screen 118 or a touch pad) that is sensitive to the touch of a user input object (e.g., a finger or a stylus). In some implementations, the touch-sensitive component can serve to implement a virtual keyboard. Other example user input components 120 include one or more buttons, a traditional keyboard, or other means by which a user can provide user input. The user input components 120 can allow for a user to provide user input, such as via a user interface 120 or in response to information displayed in a user interface 120.

The computing device 102 can also include one or more display screens 122. The display screens 122 can be, for example, display screens configured to display various information to a user, such as via the user interfaces 118. In some implementations, the one or more display screens 122 can be touch-sensitive display screens capable of receiving a user input.

The computing device 102 can further include one or more microphones 124. The one or more microphones 124 can be, for example, any type of audio sensor and associated signal processing components configured to generate audio signals associated with a user's surrounding environment. For example, ambient audio, such as a restaurant din, passing vehicle noises, etc. can be received by the one or more microphones 124, which can generate audio signals based on the surrounding environment of the user.

According to another aspect of the present disclosure, the computing device 102 can further include an artificial intelligence (AI) system 125 comprising one or more machine-learned models 126. In some implementations, the machine-learned models 126 can be operable to analyze an acoustic environment of the user. For example, the acoustic environment can include audio signals played by the computing device 102. For example, the computing device 102 can be configured to play various media files, and an associated audio signal can be analyzed by the one or more machine-learned models 126, as disclosed herein. In some implementations, the acoustic environment can include audio signals associated with a surrounding environment of the user. For example, one or more microphones 124 can obtain and/or generate audio signals associated with the surrounding environment of the user. The one or more machine-learned models 126 can be operable to analyze audio signals associated with the surrounding environment of the user.

In some implementations, the one or more machine-learned models 126 can be operable to analyze data indicative of one or more events. For example, the data indicative of one or more events can include information to be conveyed by the computing device 102 to the user and/or audio signals associated with the surrounding environment of the user. For example, in some implementations, the one or more events can include communications to the user received by the computing device 102 (e.g., text messages, SMS messages, voice messages, etc.). In some implementations, the one or more events can include external audio signals received by the computing device 102, such as audio signals associated with the surrounding environment (e.g., PA announcements, verbal communications, etc.). In some implementations, the one or more events can include notifications from applications operating on the computing device (e.g., application badges, news updates, social media updates, etc.). In some implementations, the one or more events can include prompts from an application operating on the computing device 102 (e.g., calendar reminders, navigation prompts, phone rings, etc.).

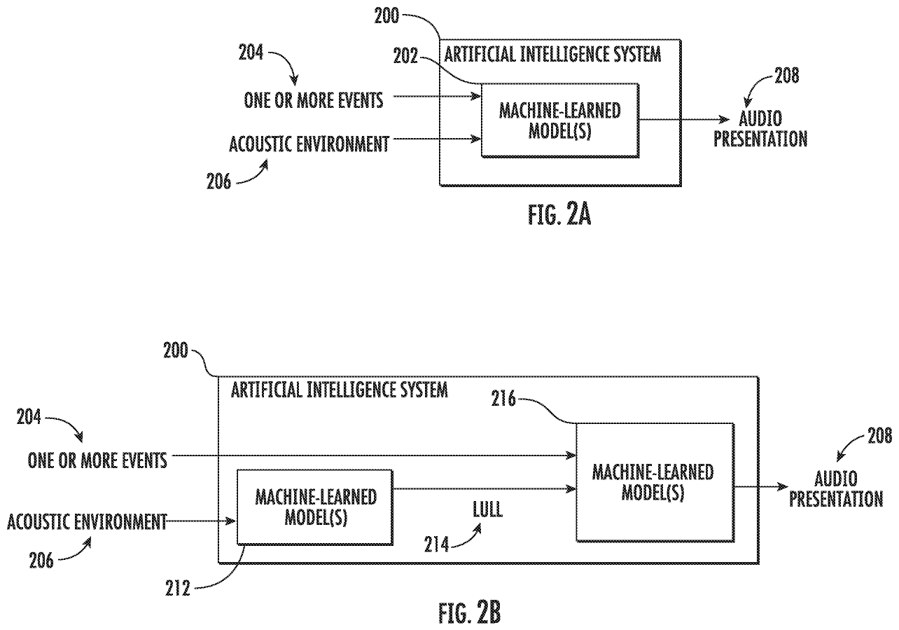

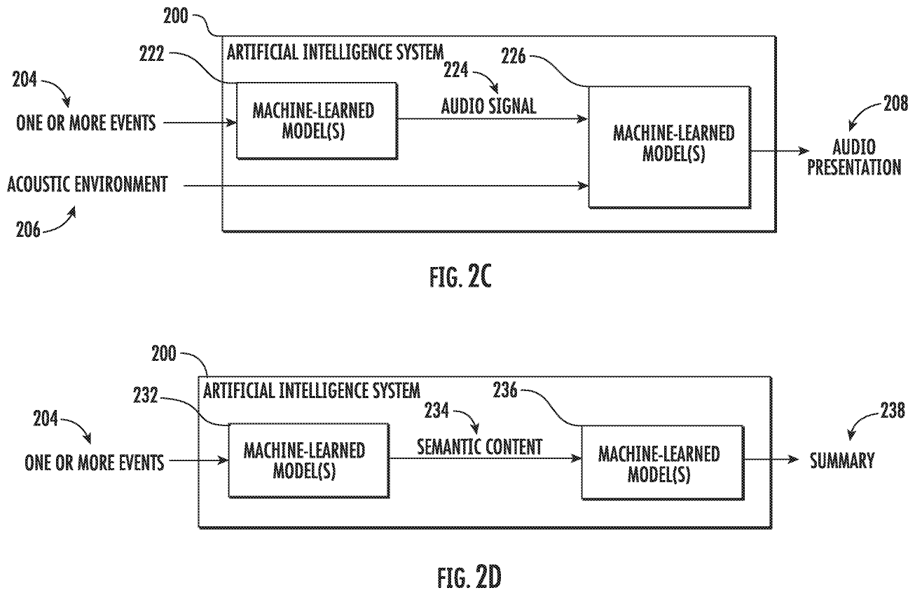

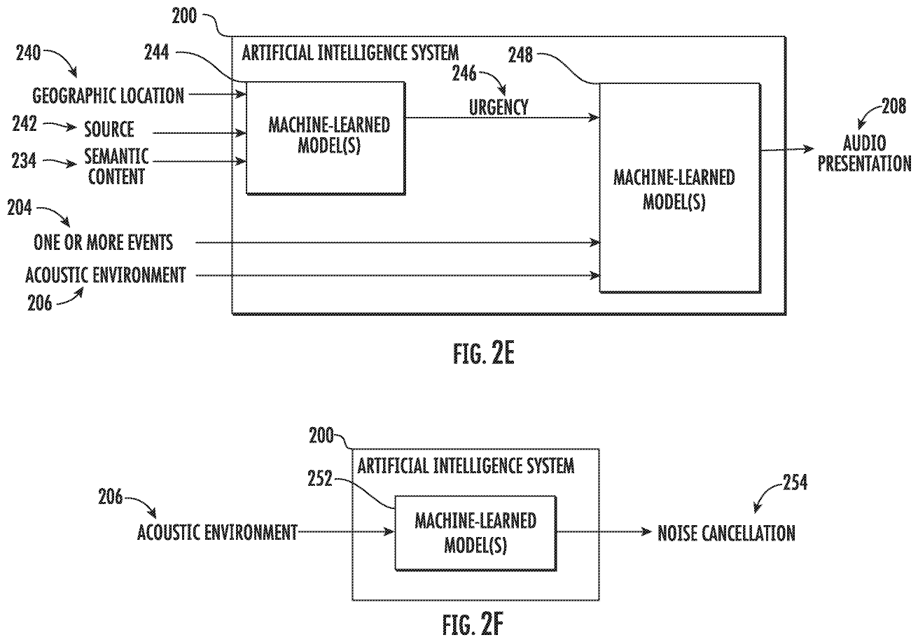

In some implementations, the one or more machine-learned models 126 can be, for example, neural networks (e.g., deep neural networks) or other multi-layer non-linear models which output various information used by the artificial intelligence system. Example artificial intelligence systems 125 and associated machine-learned models 126 according to example aspects of the present disclosure will be discussed below with further reference to FIGS. 2A-F.

The AI system 125 can be stored on-device (e.g., on the computing device 102). For example, the AI system 125 can be a local AI system 125.

The computing device 102 can further include a communication interface 128. The communication interface 128 can include any number of components to provide networked communications (e.g., transceivers, antennas, controllers, cards, etc.). In some implementations, the computing device 102 includes a first network interface operable to communicate using a short-range wireless protocol, such as, for example, Bluetooth and/or Bluetooth Low Energy, a second network interface operable to communicate using other wireless network protocols, such as, for example, Wi-Fi, and/or a third network interface operable to communicate over GSM, CDMA, AMPS, 1G, 2G, 3G, 4G, 5G, LTE, GPRS, and/or other wireless cellular networks.

The computing device 102 can also include one or more speakers 129. The one or more speakers 129 can be, for example, configured to audibly play audio signals (e.g., generate sounds waves including sounds, speech, etc.) for a user to hear. For example, the artificial intelligence system 125 can generate an audio presentation for a user, and the one or more speakers 129 can present the audio presentation to the user.

Referring still to FIG. 1, the system 100 can further include server computing system 130. The server computing system 130 can include one or more processors 132 and a memory 134. The one or more processors 132 can be any suitable processing device (e.g., a processor core, a microprocessor, an ASIC, a FPGA, a controller, a microcontroller, etc.) and can be one processor or a plurality of processors that are operatively connected. The memory 134 can include one or more non-transitory computer-readable storage mediums, such as RAM, ROM, EEPROM, EPROM, flash memory devices, magnetic disks, etc., and combinations thereof. The memory 134 can store data 136 and instructions 138 which are executed by the processor 132 to cause the server computing system 130 to perform operations.

In some implementations, the server computing system 130 includes or is otherwise implemented by one or more server computing devices. In instances in which the server computing system 130 includes plural server computing devices, such server computing devices can operate according to sequential computing architectures, parallel computing architectures, or some combination thereof.

In some implementations, the server computing system 130 can store or include an AI system 140 that can include one or more machine-learned models 142. Example artificial intelligence systems 140 and associated machine-learned models 142 according to example aspects of the present disclosure will be discussed below with further reference to FIGS. 2A-F.

In some implementations, the AI system 140 can be a cloud-based AI system 140, such as a personal cloud AI system 140 unique to a particular user. The AI system 140 can be operable to generate an audio presentation for a user via the cloud-based AI system 140.

The server computing system 130 and/or the computing device 102 can include a model trainer 146 that trains the artificial intelligence systems 125/140/170 using various training or learning techniques, such as, for example, backwards propagation of errors. In some implementations, performing backwards propagation of errors can include performing truncated backpropagation through time. The model trainer 146 can perform a number of generalization techniques (e.g., weight decays, dropouts, etc.) to improve the generalization capability of the models being trained.

In particular, the model trainer 146 can train the one or more machine-learned models 126/142/172 based on a set of training data 144. The training data 144 can include, for example, training datasets generated by the AI systems 125/140/170. For example, as will be described in greater detail herein, the training data 144 can include data indicative of one or more previous events and an associated user input descriptive of an intervention preference. In some implementations, the training data 144 can include data indicative of one or more previous events and data indicative of one or more previous user interactions with a computing device 102 in response to the one or more previous events.

In some implementations, the server computing device 130 can implement model trainer 146 to train new models or update versions on existing models on additional training data 144. As an example, the model trainer 146 can receive anonymized parameters associated with a local AI system 125 from one or more computing devices 102 and can generate a global AI system 140 using a federated learning approach. In some implementations, the global AI system 140 can be provided to a plurality of computing devices 102 to initialize a local AI system 125 on the plurality of computing devices 102.

The server computing device 130 can periodically provide the computing device 102 with one or more updated versions of the AI system 140 and/or the machine-learned models 142. The updated AI system 140 and/or machine-learned models 142 can be transmitted to the user computing device 102 via network 180.

The model trainer 146 can include computer logic utilized to provide desired functionality. The model trainer 146 can be implemented in hardware, firmware, and/or software controlling a general purpose processor. For example, in some implementations, the model trainer 146 includes program files stored on a storage device, loaded into a memory 112/134 and executed by one or more processors 111/132. In other implementations, the model trainer 146 includes one or more sets of computer-executable instructions that are stored in a tangible computer-readable storage medium such as RAM hard disk or optical or magnetic media.

In some implementations, any of the processes, operations, programs, applications, or instructions described as being stored at or performed by the server computing device 130 can instead be stored at or performed by the computing device 102 in whole or in part, and vice versa. For example, as shown, a computing device 102 can include a model trainer 146 configured to train the one or more machine-learned models 126 stored locally on the computing device 102.

The network 180 can be any type of communications network, such as a local area network (e.g., intranet), wide area network (e.g., Internet), or some combination thereof and can include any number of wired or wireless links. In general, communication over the network 180 can be carried via any type of wired and/or wireless connection, using a wide variety of communication protocols (e.g., TCP/IP, HTTP, SMTP, FTP), encodings or formats (e.g., HTML, XML), and/or protection schemes (e.g., VPN, secure HTTP, SSL).

Referring still to FIG. 1, system 100 can further include one or more peripheral devices 150. In some implementations, the peripheral device 150 can be a wearable speaker device, such as an earbud device which can communicatively couple to the computing device 102.

The peripheral device 150 can include one or more user input components 152 that are configured to receive user input. The user input component(s) 152 can be configured to receive a user interaction, such as in response to one or more events. indicative of a request. For example, the user input components 120 can be a touch-sensitive component (e.g., a touch pad) that is sensitive to the touch of a user input object (e.g., a finger or a stylus). Other example user input components 152 include one or more buttons, switches, or other means by which a user can provide user input. The user input components 152 can allow for a user to provide user input, such as to request one or more semantic entities be displayed.

The peripheral device 150 can also include one or more speakers 154. The one or more speakers 154 can be, for example, configured to audibly play audio signals (e.g., sounds, speech, etc.) for a user to hear. For example, an audio signal associated with a media file playing on the computing device 102 can be communicated from the computing device 102, such as over one or more networks 180, and the audio signal can be audibly played for a user by the one or more speakers 154. Similarly, an audio signal associated with a communication signal received by the computing device 102 (e.g., a telephone call) can be audibly played by the one or more speakers 154.

The peripheral device 150 can further include a communication interface 156. The communication interface 156 can include any number of components to provide networked communications (e.g., transceivers, antennas, controllers, cards, etc.). In some implementations, the peripheral device 150 includes a first network interface operable to communicate using a short-range wireless protocol, such as, for example, Bluetooth and/or Bluetooth Low Energy, a second network interface operable to communicate using other wireless network protocols, such as, for example, Wi-Fi, and/or a third network interface operable to communicate over GSM, CDMA, AMPS, 1G, 2G, 3G, 4G, 5G, LTE, GPRS, and/or other wireless cellular networks.

The peripheral device 150 can further include one or more microphones 158. The one or more microphones 158 can be, for example, any type of audio sensor and associated signal processing components configured to generate audio signals associated with a user's surrounding environment. For example, ambient audio, such as a restaurant din, passing vehicle noises, etc. can be received by the one or more microphones 158, which can generate audio signals based on the surrounding environment of the user.

The peripheral device 150 can include one or more processors 162 and a memory 164. The one or more processors 162 can be any suitable processing device (e.g., a processor core, a microprocessor, an ASIC, a FPGA, a controller, a microcontroller, etc.) and can be one processor or a plurality of processors that are operatively connected. The memory 164 can include one or more non-transitory computer-readable storage mediums, such as RAM, ROM, EEPROM, EPROM, flash memory devices, magnetic disks, etc., and combinations thereof. The memory 164 can store data 166 and instructions 168 which are executed by the processor 162 to cause the peripheral device 150 to perform operations.

The peripheral device 150 can store or include an AI system 170 that can include one or more machine-learned models 172. Example artificial intelligence systems 170 and associated machine-learned models 172 according to example aspects of the present disclosure will be discussed below with further reference to FIGS. 2A-F. In some implementations, the AI system 170 can be incorporated into or otherwise a part of the AI systems 125/140. For example, The AI systems 125/140/170 can be communicatively coupled and work together to generate an audio presentation for a user. As an example, various machine-learned models 124/142/172 can be stored locally as a part of an AI system 125/140/170 on the associated devices/systems 102/130/150, and the machine-learned models 124/142/172 can collectively generate an audio presentation for a user.

For example, a first machine-learned model 172 can obtain audio signals via the microphone 158 associated with the surrounding environment and perform noise cancellation of one or more portions of the audio signals obtained via the microphone 158. A second machine-learned model 125 can incorporate an audio signal associated with an event into the noise-cancelled acoustic environment generated by the first machine-learned model 172.

The AI system 170 can be trained or otherwise provided to the peripheral device 150 by the computing device 102 and/or server computing system 130, as described herein.

FIG. 1B depicts a block diagram of an example computing device 10 that performs according to example embodiments of the present disclosure. The computing device 10 can be a user computing device or a server computing device.

The computing device 10 includes a number of applications (e.g., applications 1 through N). Each application contains its own machine learning library and machine-learned model(s). For example, each application can include a machine-learned model. Example applications include a text messaging application, an email application, a dictation application, a virtual keyboard application, a browser application, etc.

As illustrated in FIG. 1B, each application can communicate with a number of other components of the computing device, such as, for example, one or more sensors, a context manager, a device state component, and/or additional components. In some implementations, each application can communicate with each device component using an API (e.g., a public API). In some implementations, the API used by each application is specific to that application.

FIG. 1C depicts a block diagram of an example computing device 50 that performs according to example embodiments of the present disclosure. The computing device 50 can be a user computing device or a server computing device.

The computing device 50 includes a number of applications (e.g., applications 1 through N). Each application is in communication with a central intelligence layer. Example applications include a text messaging application, an email application, a dictation application, a virtual keyboard application, a browser application, etc. In some implementations, each application can communicate with the central intelligence layer (and model(s) stored therein) using an API (e.g., a common API across all applications).

The central intelligence layer includes a number of machine-learned models. For example, as illustrated in FIG. 1C, a respective machine-learned model (e.g., a model) can be provided for each application and managed by the central intelligence layer. In other implementations, two or more applications can share a single machine-learned model. For example, in some implementations, the central intelligence layer can provide a single model (e.g., a single model) for all of the applications. In some implementations, the central intelligence layer is included within or otherwise implemented by an operating system of the computing device 50.

The central intelligence layer can communicate with a central device data layer. The central device data layer can be a centralized repository of data for the computing device 50. As illustrated in FIG. 1C, the central device data layer can communicate with a number of other components of the computing device, such as, for example, one or more sensors, a context manager, a device state component, and/or additional components. In some implementations, the central device data layer can communicate with each device component using an API (e.g., a private API).

FIG. 2A depicts a block diagram of an example AI system 200 including one or more machine-learned models 202 according to example aspects of the present disclosure. In some implementations, the AI system 200 can be stored on a computing device/system, such as a computing device 102, a computing system 130, and/or a peripheral device 150 depicted in FIG. 1. The AI system 200 can be an AI system configured to generate an audio presentation 208 for a user. In some implementations, the AI system 200 is trained to receive data indicative of one or more events 204.

For example, the data indicative of one or more events can include information to be conveyed by the computing device/system to the user and/or audio signals associated with the surrounding environment of the user. For example, in some implementations, the one or more events can include communications to the user received by the computing device/system (e.g., text messages, SMS messages, voice messages, etc.). In some implementations, the one or more events can include external audio signals received by the computing device/system, such as audio signals associated with the surrounding environment (e.g., PA announcements, verbal communications, etc.). In some implementations, the one or more events can include notifications from applications operating on the computing device (e.g., application badges, news updates, social media updates, etc.). In some implementations, the one or more events can include prompts from an application operating on the computing device 102 (e.g., calendar reminders, navigation prompts, phone rings, etc.).

In some implementations, the AI system 200 is trained to also receive data indicative of an acoustic environment 206 of the user. For example, the data indicative of the acoustic environment 206 can include audio signals playing for a user on the computing device/system (e.g., music, podcasts, audiobooks, etc.). The data indicative of the acoustic environment 206 can also include audio signals associated with the surrounding environment of the user.

As depicted in FIG. 2A, the data indicative of the one or more events 204 and the data indicative of the acoustic environment 206 can be input into the AI system 200, such as into one or more machine-learned models 202. The AI system 200 can generate an audio presentation 208 for a user based at least in part on the data indicative of the one or more events 204 and the data indicative of the acoustic environment 206. For example, the audio presentation 208 (e.g., data indicative thereof) can be received as an output of the AI system 200 and/or the one or more machine-learned models 202.

The AI system 200 can generate the audio presentation 208 by determining whether and when to incorporate audio signals associated with the one or more events 204 into the acoustic environment 206. Stated differently, the AI system 200 can intelligently curate audio information for a user.

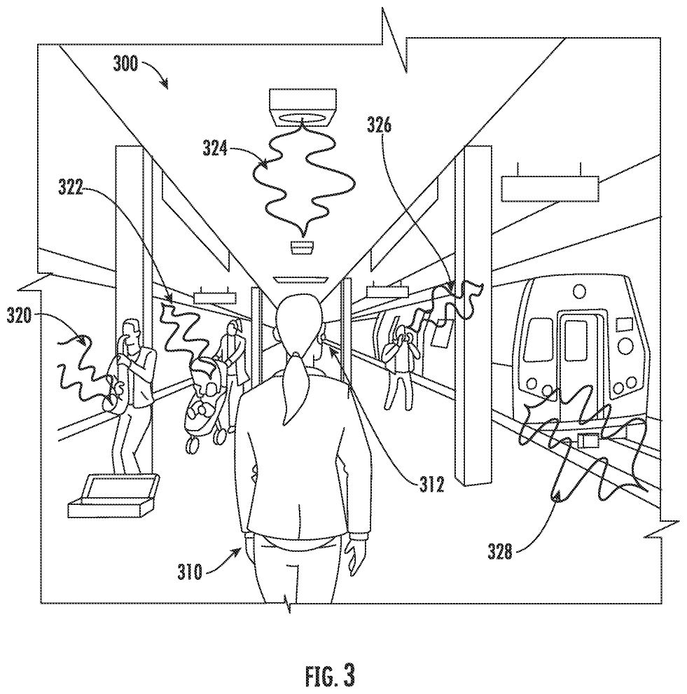

For example, referring now to FIG. 3, an example acoustic environment 300 for a user 310 is depicted. As shown, the user 310 is wearing a wearable speaker device 312 (e.g. earbuds). In some implementations, the acoustic environment 300 can include audio content being played for the user 310, such as music streaming from the user's personal computing device to the wearable speaker device 312.

However, the acoustic environment 300 for the user 310 may also include additional audio signals, such as audio signals 320-328 associated with a surrounding environment of the user. Each of the audio signals 320-328 can be associated with a unique event. For example, as depicted, an audio signal 320 can be an audio signal generated by a musician on a loading platform of a train station. Another audio signal 322 can be an audio signal from a nearby child laughing. An audio signal 324 can be an announcement over a PA system, such as an announcement that a particular train is boarding. An audio signal 326 can be an audio signal from a nearby passenger shouting to get the attention of other members in his traveling party. An audio signal 328 can be an audio signal generated by a nearby train, such as audio signals generated by the train traveling on the tracks or a horn indicating the train is about to depart.

The cacophony of audio signals 320-328 in the surrounding environment of the user as well as any audio content playing for the user 310 may have the potential to overwhelm the user 310. Thus, in response, a user 310 desiring to listen to audio content on the user's personal device may use a noise cancelling mode to cancel the audio signals 320-328, thereby allowing only the audio content playing on the user's personal device to be presented to the user. However, this may cause the user 310 to miss important audio information, such as an announcement over a PA system 324 that the user's train is departing. Thus, in some situations, in order to ensure the user 310 does not miss important audio content, the user 310 may have to turn off the noise-cancelling mode or remove the wearable speaker device 312 altogether.

Further, even when the user 310 is able to listen to audio content, such as audio content playing on the user's personal device (e.g., smartphone), such audio content may be frequently interrupted by other events, such as audio signals associated with communications, notifications, and/or prompts provided by the user's personal device. In response, the user may select a “silent” mode in which any audio signals associated with on-device notifications aren't provided, but this could also cause the user to similarly miss important information, such as text messages from a spouse or notifications from a travel application about a travel delay.

Referring back to FIG. 2A, the AI system 200 can intelligently curate the user's acoustic environment by determining whether and when to incorporate audio signals associated with one or more events into the user's acoustic environment. For example, according to additional example aspects of the present disclosure, generating the audio presentation 208 by the AI system 200 can include determining a particular time to incorporate an audio signal associated with the one or more events 204 into the acoustic environment 206.

For example, referring now to FIG. 2B, in some implementations, the data indicative of the acoustic environment 206 can be input into one or more machine-learned model 212 configured to identify a lull 214 in the acoustic environment 206. For example, the lull 214 can be a portion of the acoustic environment 206 corresponding to a relatively quiet period as compared to the other portions of the acoustic environment 206. For example, for a user listening to a streaming music playlist, a lull 214 may correspond to a transition period between consecutive songs. Similarly, for a user listening to an audiobook, a lull 214 may correspond to a period between chapters. For a user on a telephone call, a lull 214 may correspond to a time period after the user hangs up. For a user having a conversation with another person, a lull 214 may correspond to a break in the conversation. An example lull 214 is described in greater detail with respect to FIGS. 6A and 6B.

In some implementations, the lull 214 can be identified prior to audio content being played for the user. For example, playlists, audiobooks, and other audio content can be analyzed by the one or more machine-learned models 212 and lulls 214 can be identified, such as by a server computing device remote from the user's computing device. Data indicative of the lulls 214 can be stored and provided to the user's computing device by the server computing system.

In some implementations, the lull 214 can be identified in real-time or near real-time. For example, the one or more machine-learned models 212 can analyze audio content playing on the user's computing device and can analyze an upcoming portion of the audio content (e.g., a 15 second window of upcoming audio content to be played in the near future). Similarly, one or more machine-learned models 212 can analyze audio signals in the acoustic environment 206 to identify lulls 214 in real-time or near real-time.

In some implementations, the AI system 200 can select a lull 214 as the particular time to incorporate an audio signal associated with the one or more events into the acoustic environment 206. For example, data indicative of the lull 214 and the data indicative of the one or more events 204 can be input into a second machine-learned model 216, which can generate the audio presentation 208 by incorporating an audio signal associated with the one or more events 204 into the acoustic environment 206 during the lull 214.

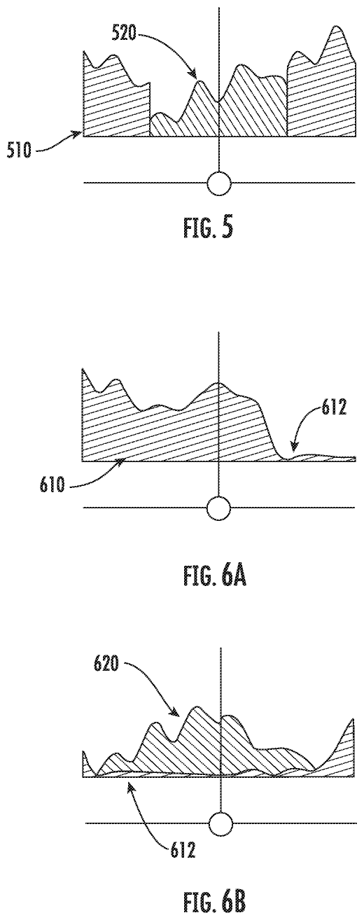

In some implementations, one or more intervention tactics can be used to incorporate an audio signal associated with the one or more events 204 into the acoustic environment 206. Example intervention tactics according to example aspects of the present disclosure are described in greater detail with respect to FIGS. 5-13.

Referring now to FIG. 2C, in some implementations, the AI system 200 can generate an audio signal 224 associated with the one or more events. For example, the data indicative of the one or more events 204 can be input into one or more machine learned models 222 configured to generate the audio signal 224 associated with the one or more events 204. For example, a text-to-speech (TTS) machine-learned model 222 can convert text associated with the one or more events 204 (e.g., a text message) into an audio signal 224. Similarly, other machine-learned models 222 can generate audio signals 224 associated with other events 204. For example, in some implementations, one or more machine-learned models 222 can generate tonal audio signals 224 which can convey a context of the one or more events 204. For example, different audio signals 224 can be generated for different navigational prompts, such as by using a first tone to indicate a right turn and a second tone to indicate a left turn.

The audio signal 224 (e.g., data indicative thereof) and the acoustic environment 206 (e.g., data indicative thereof) can be input into one or more machine-learned models 226, which can generate the audio presentation (e.g., data indicative thereof) 208 for the user. For example, the audio signal 224 can be incorporated into the acoustic environment 206, as described herein.

Referring now to FIG. 2D, in some implementations, the AI system 200 can generate an audio signal based at least in part on a semantic content 234 of the one or more events 204. For example, the data indicative of the one or more events 204 can be input into one or more machine-learned models 232 configured to determine a semantic content 234 of the one or more events 204. For example, an announcement over a PA system in a surrounding environment of the user can be analyzed to determine the semantic content 234 of the announcement, such as by using a machine-learned model 232 configured to convert speech to text. Further, in some implementations, the semantic content 234 can be input into one or more machine-learned models 236 configured to generate a summary 238 of the semantic content 234.

For example, the acoustic environment 206 of a user sitting at an airport is likely to occasionally include PA system announcements with information regarding various flights, such as a flight destination, flight number, departure time, and/or other information. However, the user may only wish to hear announcements regarding his/her upcoming flight. In some implementations, the semantic content 234 of each flight announcement (e.g., each event) can be determined by the one or more machine-learned models 232. For most of the events 204 (e.g., most of the flight announcements), upon analyzing the semantic content, the AI system 200 can determine that audio signals associated with the events 204 do not need to be incorporated into the acoustic environment 206 of the user. For example, the AI system 200 can determine to not incorporate an audio signal associated with the one or more events into the acoustic environment 204.

However, upon obtaining an audio signal for a PA system announcement for the user's flight (e.g., a particular event), the AI system 200 may determine that an audio signal associated with the announcement should be incorporated into the acoustic environment 206 of the user. For example, the AI system 200 can recognize that the flight number in the semantic content 234 of the announcement corresponds to the flight number on a boarding pass document or a calendar entry stored on the user's personal device.

In some implementations, the AI system 200 can generate the audio presentation 208 by selecting a current time period to provide the audio signal associated with the one or more events to the user. For example, the AI system 200 can pass the PA system announcement regarding the user's flight through to the user as it is received but noise-cancel the other announcements.

In some implementations, the AI system can select a future time period to provide an audio signal associated with the announcement (e.g., during a lull, as described herein). However, while this approach can intelligently curate (e.g., filter) audio signals the user may not care about, passing through or replaying the PA announcements about the user's flight may present additional and unnecessary information than the user needs.

To better curate the audio information presented to the user in the audio presentation 208, in some implementations, the semantic content 234 of one or more events 204 can be summarized. For example, rather than replaying the PA system announcement for the user, a summary 238 of the announcement (e.g., a single event) can be generated by one or more machine-learned models 236 using the semantic content 234. For example, the AI system 200 can generate a summary 238 in which an audio signal is generated with the information “your flight is boarding now.”

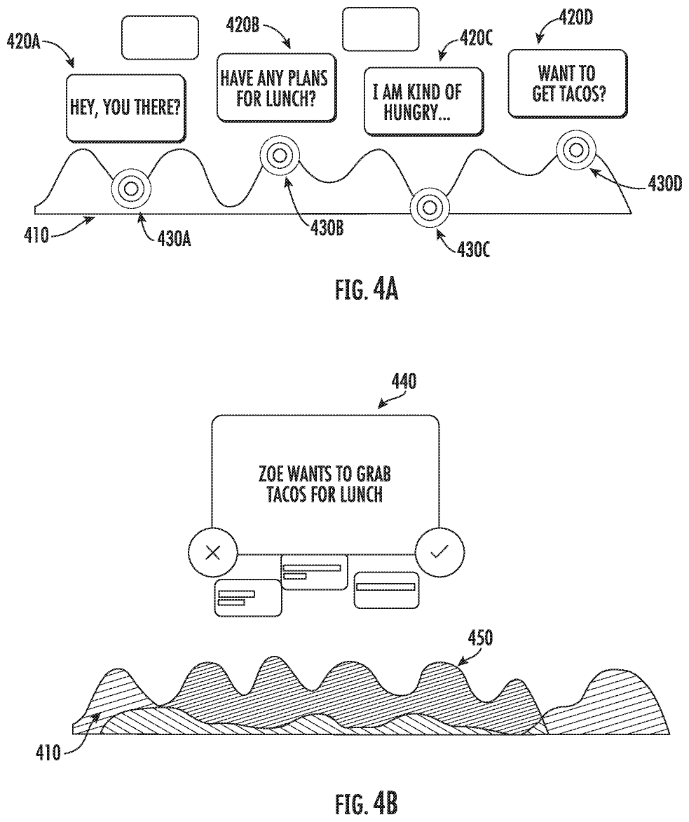

Similarly, in some implementations, a plurality of events can be summarized for the user. For example, referring now to FIG. 4A, an example acoustic environment 410 for a user is depicted. The acoustic environment 410 can be, for example, audio content playing for the user over a period of time. At various times, text messages 420A-D (e.g., events) can be received by the user, such as via the user's personal device. Each of the text messages 420A-D can be an event which corresponds to an associated receipt time 430A-D as depicted in reference to the acoustic environment 410. The text messages 420A-D can be, for example, a text message chain for a group of people trying to decide whether and where to go for lunch. Each of the events 420A-D (e.g., text messages 420A-D) can be input into an AI system, and corresponding semantic content can be determined for the events 420A-D. Further, referring now to FIG. 4B, a summary 430 can be generated based at least in part on the semantic content of the events 420A-D. For example, the summary 430 can summarize the semantic content of the text messages 420A-D in which the summary 430 notes that the group has decided to get tacos for lunch.

While FIGS. 4A and 4B visually depict various notifications and a summary, the information associated with the events and summary can be provided to the user as audio content. For example, a summary 440 of the text messages 420A-D can be incorporated into the acoustic environment 410 which is played for the user. For example, an audio signal 450 can be generated by the AI system 200 and the audio signal 440 can be incorporated into the acoustic environment 410. For example, a text-to-speech machine-learned model can audibly play the summary for the user during a lull (or other particular time) in the acoustic environment 410, as described herein.

Referring now to FIG. 2E, in some implementations, an AI system 200 can generate an audio presentation 208 based at least in part on an urgency 246 of the one or more events. For example, as depicted, in some implementations, a semantic content 234 of one or more events, a geographic location 240, and/or a source 242 associated with one or more events can be input into one or more machine-learned models 244 to determine an urgency 246 of the one or more events. The semantic content 234 can be, for example, the semantic content generated by one or more machine-learned models 232 as depicted in FIG. 2D.

For example, a geographic location 240 of the user can be indicative of the user's acoustic environment and/or a user's preference. For example, when a user is at the user's workplace, the user may prefer to only be provided audio content associated with certain sources 242 and/or in which the semantic content 234 is particularly important and/or relevant to the user's work. However, when the user is at the user's home, the user may prefer to be provided audio content associated with a broader range and/or different set of sources 242 and/or in which the semantic content 234 is associated with a broader range and/or different set of topics.

Similarly, when a user is traveling, the user may prefer to not be provided certain audio content. For example, the AI system 200 can determine that a user is traveling using one or more machine-learned models 246 based upon the user's changing geographic location 240 as the user is traveling. For example, a changing geographic location 240 of the user along a street can be indicative that the user is driving. In such a situation, the one or more machine-learned models 244 can use the geographic location 240 to determine that only events with a relatively high urgency 246 should be incorporated into an acoustic presentation 208.

As an example, a user at her workplace (e.g., geographic location 240) receiving a text message from her spouse (e.g., source 242) stating that the user's child is sick at school (e.g., semantic content 234) can be determined by the one or more machine-learned models 244 to have a relatively high urgency 246. In contrast, a user at her workplace (e.g., geographic location 240) receiving a text message from the user's spouse (e.g., a source 242) requesting that the user pick up a gallon of milk on her way home (e.g., semantic content 234) can be determined by the one or more machine-learned models 244 to have a relatively low urgency 246.

Similarly, a user driving to the airport (e.g., geographic location 240) receiving a text message from his friend (e.g., source 242) asking the user if he'd like to go to a baseball game (e.g., semantic content 234) can be determined by the one or more machine-learned models 244 to have a relatively low urgency 246. In contrast, a notification from a travel application operating on the user's smartphone (e.g., source 242) received while the user is traveling to the airport (e.g., geographic location 240) indicating that the user's upcoming flight has been delayed (e.g., semantic content 234) can be determined by the one or more machine-learned models 2442 have a relatively high urgency 246.

In some implementations, other data can also be used to determine an urgency 246. For example, one or more contextual signifiers (not depicted) can also be used to determine an urgency 246. As an example, a time of day (e.g., during a user's typical workday) may indicate that the user is likely to be engaged in work, even if the user is at her home (e.g., working remotely). Similarly, a day of the week (e.g., a weekend) may indicate that a user is likely at not engaged in work. Additionally, an activity the user is performing may also be a contextual signifier. As an example, a user editing a document or drafting an email may indicate the user is performing a work activity. Similarly, a user navigating to a destination (e.g., driving a vehicle) may indicate that the user is busy and thus should not be interrupted as often. In such situations the one or more machine-learned models 248 can generate the audio presentation 208 using such contextual signifiers.

The urgency 246 of an event 204 and the user's acoustic environment 206 can be input into one or more machine-learned models 248 to generate the audio presentation 208. For example, the urgency 246 of an event 204 can be used to determine if, when, and/or how an audio signal associated with an event 204 is incorporated into the acoustic environment 206. For example, an event 204 with a relatively high urgency 246 may be incorporated into the acoustic environment 206 more quickly than an event 204 with a relatively low urgency 246. Further, different tones can be used to both identify a type of notification and an associated urgency. For example, a buzzing tone at a first frequency (e.g., a low frequency) can indicate a low urgency text message has been received, while a buzzing tone at a second frequency (e.g., a high frequency) can indicate a high urgency text message has been received. In this way, the AI system 200 can generate an audio presentation 208 by incorporating an audio signal associated with one or more events 204 into an acoustic environment 206 based at least in part on an urgency 246 of the one or more events 204.

Referring now to FIG. 2F, in some implementations, AI system 200 can generate an audio presentation by cancelling at least a portion of an audio signal associated with an acoustic environment 206. For example, as depicted, the acoustic environment 206 (e.g., data indicative thereof) can be input into one or more machine-learned models 252 to generate a noise cancellation 254 (e.g., a cancelled audio signal). As an example, the one or more machine-learned models 252 of the AI system 200 can perform active noise cancellation to allow certain ambient sounds (e.g., rainfall, birds chirping, etc.) to pass through while canceling harsher, more disruptive sounds (cars honking, people yelling, etc.). The noise cancellation 254 can be incorporated into an audio presentation, such as an audio presentation 208 described herein.

Referring generally to FIGS. 2A-F, the AI systems 200 and associated machine-learned models can cooperatively work to intelligently curate a user's acoustic environment 206. For example, event(s) 204 can be analyzed to determine an urgency 246 of the event(s) 204. The event(s) 204 can be summarized based on the semantic content 234 of the event(s) 204. Audio signal(s) associated with the event(s) 204 can be generated by the AI system 200. The AI system 200 can determine a particular time to present the audio signal(s) to the user, such as at a convenient time The audio signal(s) can be incorporated into the user's acoustic environment 206, such as music playing on a user's smartphone, at the particular time.

Moreover, in some implementations, the AI systems can generate an audio presentation 208 for a user based at least in part on a user input descriptive of a listening environment. For example, a user may select one of a plurality of different listening environments which can include various thresholds for presenting audio information to the user. As an example, on one end of the spectrum, a user may select a real-time notification mode in which each event having an associated audio signal is presented to the user in real-time or near real-time. On another end of the spectrum, a user may select a silence mode in which all external sounds in a surrounding environment are cancelled. One or more intermediate modes can include a summary mode in which events are summarized, an ambient update mode in which white noise is generated and tonal audio information is provided (e.g., tones indicative of various events), and/or an environmental mode in which only audio content from the user's surroundings are provided. As a user changes her listening mode, the AI system 200 can adjust how audio information is incorporated into her acoustic environment 206.

According to additional example aspects of the present disclosure, in some implementations, one or more intervention tactics can be used to incorporate audio signals associated with one or more events into the user's acoustic environment. Referring now to FIG. 5, an example “barge” intervention tactic is depicted. For example, an acoustic environment 510 is depicted, and the acoustic environment can include one or more audio signals, as described herein. In some implementations, an AI system can use a barge tactic to interrupt the acoustic environment 510 to incorporate an audio signal 520 associated with one or more events. For example, as depicted, the audio signal(s) of the acoustic environment 510 are stopped completely while the audio signal(s) associated with the one or more events 520 are played. Once the audio signal(s) associated with the one or more events 520 have been played, the acoustic environment 510 is resumed. The barge tactic can be used, for example, for events which have a relatively high urgency.

Referring now to FIGS. 6A and 6B, an example “slip” intervention tactic is depicted. For example, as depicted in FIG. 6A, an acoustic environment 610 is shown. At 612, a lull occurs. For example, as described herein, the lull 612 can correspond to a relatively quiet portion of the acoustic environment 610. As shown in FIG. 6B, an audio signal associated with one or more events 620 can be incorporated into the acoustic environment 610 by playing the audio signal 620 during the lull 612. The slip intervention tactic can be used, for example, for events which do not have a relatively high urgency or to present audio information at a time more convenient or appropriate for the user.

Referring now to FIG. 7, an example “filter” intervention tactic is depicted. For example, as depicted in FIG. 7, an acoustic environment 710 is shown. At 712, the filter tactic is applied to the acoustic environment 710. For example, as shown, only certain frequencies are passed through. An audio signal associated with one or more events 720 can then be incorporated into the acoustic environment 710 by playing the audio signal 720 while the filtering 712 is occurring.

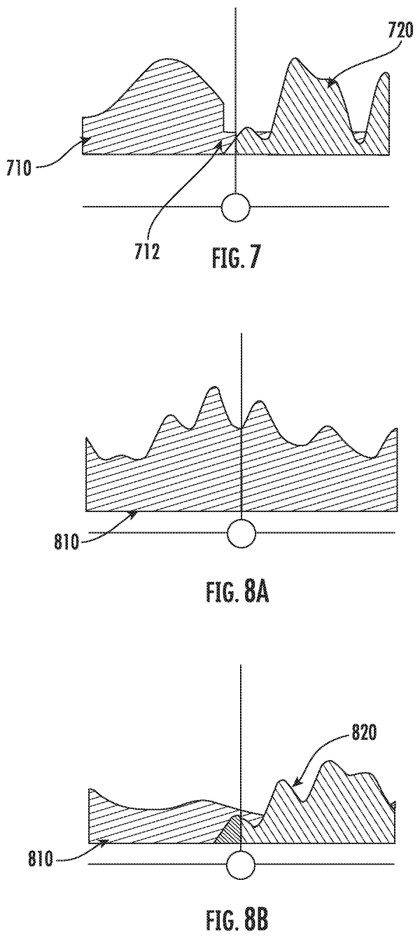

Referring now to FIGS. 8A and 8B, an example “stretch” intervention tactic is depicted. For example, as depicted in FIG. 8A, and acoustic environment 810 is shown, as depicted in FIG. 8B, the acoustic environment has been “stretched” by holding and continuously playing a first portion of the first audio signal by stretching the first portion of the audio signal. For example, a note of a song can be held for a period of time. While the acoustic environment 810 is stretched, an audio signal associated with one or more events 820 can then be incorporated into the acoustic environment 810 by playing the audio signal 820 while the stretching is occurring.

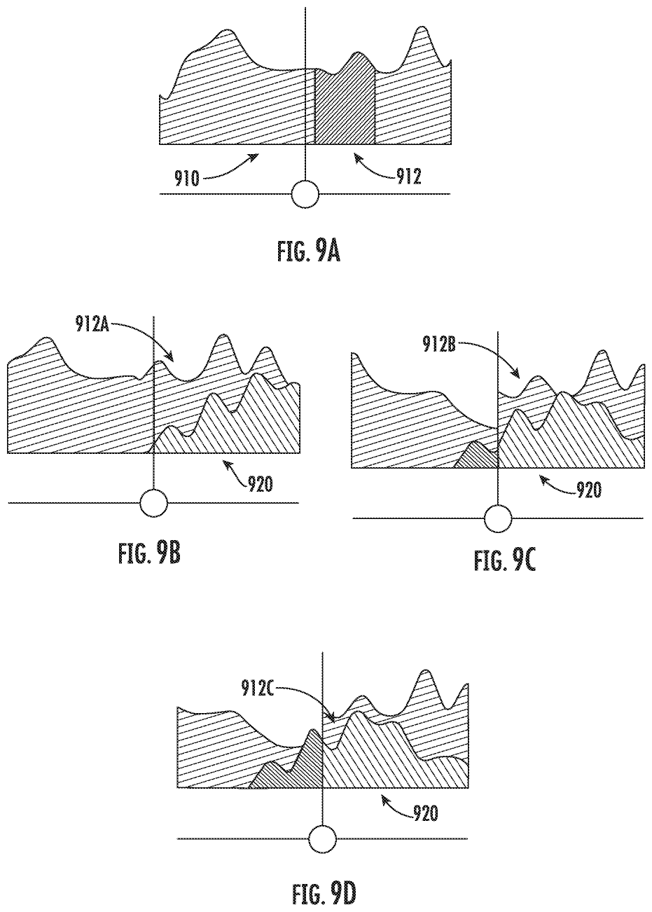

Referring now to FIGS. 9A-D, an example “loop” intervention tactic is depicted. For example, as depicted in FIG. 9A, an acoustic environment 910 is shown. A portion 912 (e.g., a slice) of the acoustic environment 910 can be selected. For example, the portion 912 can be an upcoming portion of the acoustic environment 910 at which an audio signal associated with one or more events 920 is to be incorporated into the acoustic environment 910. As depicted in FIG. 9B, when the portion 912A is played (e.g., when the acoustic environment 910 reaches the first portion), the audio signal associated with the one or more events 920 can be incorporated into the acoustic environment 910 by playing the audio signal 920. As shown in FIG. 9C, upon completing playing the portion 912A, a second portion 912B can be played while the audio signal 920 is played. Upon completing playing the portion 912B, a third portion 912C can be played while the audio signal 920 is played. Successive portions 912 can similarly be repeatedly played until the completion of the audio signal 920. In this way, the loop intervention tactic can hold and repeatedly play a portion 912 of the acoustic environment 910 by repeatedly looping the portion 912 of the acoustic environment 910.

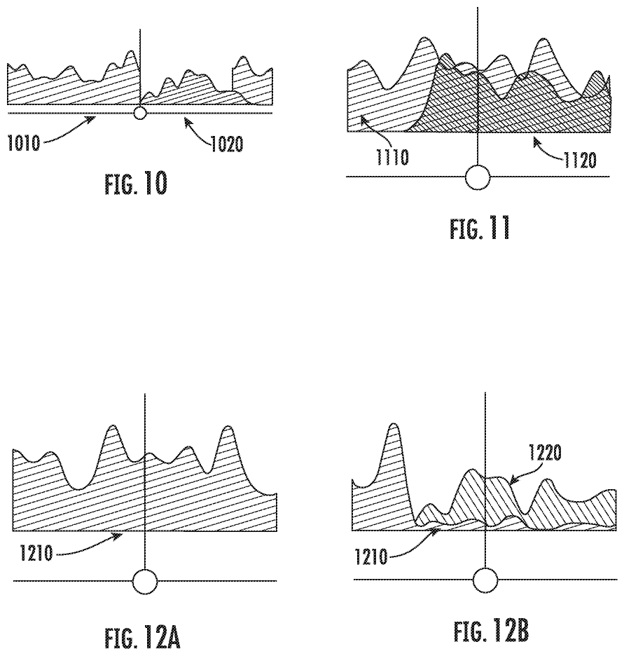

Referring now to FIG. 10, an example “move” intervention tactic is depicted. For example, as depicted in FIG. 10, an acoustic environment 1010 is shown. As shown, the perceived direction of the acoustic environment 1010 can be changed while an audio signal associated with one or more events 1020 is played. For example, the perceived direction of the acoustic environment 1010 can be changed by shifting a stereo acoustic environment 1010 from a left side to a right side, a front side to a back side, etc. In some implementations, changing the perceived direction can include incorporating a “muffling” effect in which the acoustic environment 1010 is perceived to be at a distance from the user.

Referring now to FIG. 11, an example “overlay” intervention tactic is depicted. For example, as depicted in FIG. 11, an acoustic environment 1110 is shown. As shown, an audio signal associated with one or more events 1120 is overlaid with the acoustic environment 1110 by playing both the acoustic environment 1110 and the audio signal 1120 at the same time. The overlay intervention tactic can be used to provide context to the user. For example, the first tone can be used to indicate a driver should make a left turn while a second tone can be used to indicate a right turn.

Referring now to FIGS. 12A and 12B, an example “duck” intervention tactic is depicted. For example, as depicted in FIG. 12A, an acoustic environment 1210 is shown. However, as depicted in FIG. 12B, the volume of the acoustic environment 1210 has been lowered while an audio signal associated with one or more events 1220 is played. The duck intervention tactic can be used to lower the volume of the acoustic environment 1210 either gradually or abruptly. The speed at which the volume of the acoustic environment 1210 is lowered can be used, for example, to provide context for the audio signal 1220, such as to indicate an urgency of the one or more events.

Referring now to FIG. 13, an example “glitch” intervention tactic is depicted. For example, as depicted in FIG. 13, an acoustic environment 1310 is shown. As shown, an audio signal associated with one or more events 1320 can be generated by manufacturing a flaw in the acoustic environment 1310. For example, the flaw can be similar to a record scratch or a skipping of a digital track. The flaw can be used to provide context to a user. For example, a glitch tactic can be used for a runner listening to music to tick off distance or time markers (e.g., every mile, every minute, etc.).

Referring generally to FIGS. 5-13, the intervention tactics described herein can be used individually or in conjunction with one another. For example, a stretch tactic and a duck tactic can be used to stretch and lower the volume of the acoustic environment. Further, it should be noted that the acoustic environments described herein can include audio content playing for a user and/or the cancellation of audio signals. For example, a user listening in an ambient mode may have certain sounds (e.g., the sound of rainfall) passed through to the user while other sounds (cars honking) are cancelled.

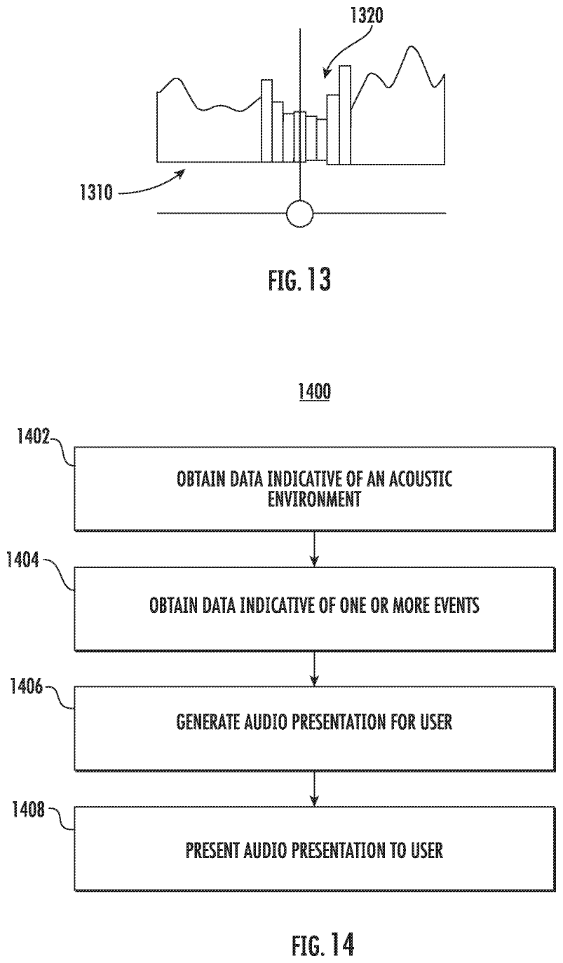

FIG. 14 depicts a flow diagram of an example method 1400 for generating an audio presentation. Although FIG. 14 depicts steps performed in a particular order for purposes of illustration and discussion, the methods of the present disclosure are not limited to the particularly illustrated order or arrangement. The various steps of the method 1400 can be omitted, rearranged, combined, and/or adapted in various ways without deviating from the scope of the present disclosure.

At 1402, the method can include obtaining data indicative of an acoustic environment. For example, in some implementations, the data indicative of the acoustic environment can include audio signals playing for a user, such as on the user's portable user device. In some implementations, the data indicative of the acoustic environment can include audio signals associated with a surrounding environment of a user. For example, one or more microphones can detect/obtain the audio signals associated with the surrounding environment.

At 1404, the method can include obtaining data indicative of one or more events. For example, in some implementations, the data indicative of the one or more events can be obtained by a portable user device. The one or more events can include information to be conveyed to the user, such as by the portable user device, and/or a portion of the audio signal associated with the surrounding environment of the user. In some implementations, the one or more events can include communications to the user received by the portable user device (e.g., text messages, SMS messages, voice messages, etc.). In some implementations, the one or more events can include external audio signals received by the portable user device, such as audio signals associated with the surrounding environment (e.g., PA announcements, verbal communications, etc.). In some implementations, the one or more events can include notifications from applications operating on the portable user device (e.g., application badges, news updates, social media updates, etc.). In some implementations, the one or more events can include prompts from an application operating on the portable user device (e.g., calendar reminders, navigation prompts, phone rings, etc.).

At 1406, the method can include generating, by an AI system, an audio presentation for the user based at least in part on the data indicative of the one or more events and the data indicative of the acoustic environment of the user. For example, in some implementations, the AI system can be an on-device AI system of a portable user device.

At 1408, the method can include presenting the audio presentation to the user. For example, in some implementations, the audio presentation can be presented by a portable user device. For example, the portable user device can present the audio presentation to the user via one or more wearable speaker devices, such as one or more earbuds.

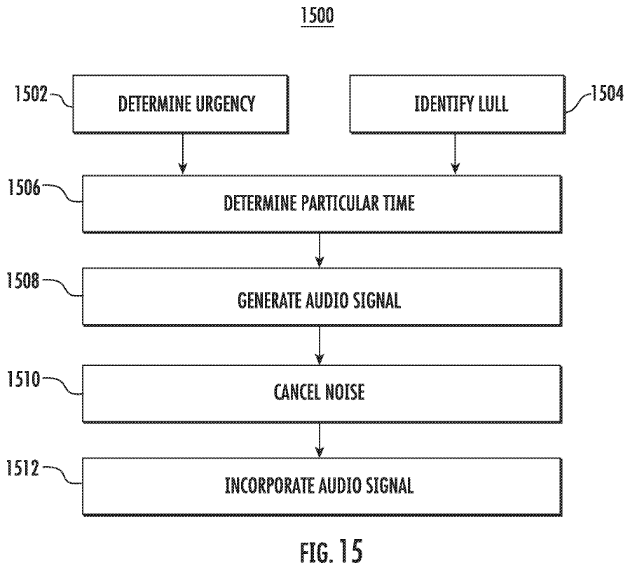

Referring now to FIG. 15, a flow diagram of an example method 1500 of generating an audio presentation for a user is depicted. Although FIG. 15 depicts steps performed in a particular order for purposes of illustration and discussion, the methods of the present disclosure are not limited to the particularly illustrated order or arrangement. The various steps of the method 1500 can be omitted, rearranged, combined, and/or adapted in various ways without deviating from the scope of the present disclosure.

At 1502, the method can include determining an urgency of one or more events. For example, in some implementations, an AI system can use one or more machine-learned models to determine an urgency of one or more events based at least in part on a geographic location of the user, a source associated with the one or more events, and/or semantic content of the one or more events.

At 1504, the method can include identifying a lull in the acoustic environment. For example, the lull can be a portion of the acoustic environment corresponding to a relatively quiet period as compared to the other portions of the acoustic environment. For example, for a user listening to a streaming music playlist, a lull may correspond to a transition period between consecutive songs. Similarly, for a user listening to an audiobook, a lull may correspond to a period between chapters. For a user on a telephone call, a lull may correspond to a time period after the user hangs up. For a user having a conversation with another person, a lull may correspond to a break in the conversation.

At 1506, the method can include determining a particular time to incorporate an audio signal associated with the one or more events into the acoustic environment. For example, in some implementations, the particular time can be determined (e.g., selected) based at least in part on the urgency of the one or more events. For example, events which have a relatively higher urgency may be presented sooner than events which have a relatively lower urgency. In some implementations, an AI system can select an identified lull as the particular time to incorporate the audio signal associated with the one or more events. In some implementations, determining the particular time to incorporate the audio signal associated with the one or more events can include determining to not incorporate an audio signal into the acoustic environment. In some implementations, determining the particular time can include determining a particular time to incorporate a first audio signal into the acoustic environment while determining to not incorporate a second audio signal.

At 1508, the method can include generating an audio signal. For example, in some implementations, the audio signal can be a tone indicative of an urgency of one or more events. In some implementations, the audio signal associated with the one or more events can include a summary of semantic content of the one or more events. For example, in some implementations, the audio signal, such as a summary, can be generated by a text-to-speech (TTS) model.

At 1510, the method can include canceling noise. For example, in some implementations, generating the audio presentation for the user can include canceling one or more audio signals associated with the surrounding environment of the user.

At 1512, the method can include incorporating the audio signal associated with the one or more events into the acoustic environment of the user. For example, in some implementations, one or more intervention tactics can be used. For example, the AI system can use a barge intervention tactic in which an audio signal playing for the user on the computing system is interrupted to make room for the audio signal associated with the one or more events. In some implementations, the AI system can use a slip intervention tactic to play the audio signal associated with the one or more events during a lull in the acoustic environment. In some implementations, a filter intervention tactic can be used in which an audio signal playing for the user is filtered (e.g., only certain frequencies of the audio signal are played) while the audio signal associated with the one or more events is played. In some implementations, a stretch intervention tactic can be used wherein the AI system holds and repeatedly plays a portion of an audio signal playing on a device (e.g., holding a note of a song) while the audio signal associated with the one more events is played. In some implementations, a loop intervention tactic can be used wherein the AI system selects a portion of an audio signal playing on a device and repeatedly plays the portion (e.g., looping a 3 second slice of audio) while the audio signal associated with one or more events is played. In some implementations, a move intervention tactic can be used wherein the AI system changes a perceived direction of an audio signal playing on the computing system (e.g., left to right, front to back, etc.) while the audio signal associated with the one more events is played. In some implementations, an overlay intervention tactic can be used wherein the AI system overlays an audio signal associated with the one or more events on an audio signal playing on a device (e.g., at the same time). In some implementations, a duck intervention tactic can be used wherein an AI system reduces a volume of an audio signal playing on a device (e.g., making the first audio signal quieter) while playing the audio signal associated with the one or more events. In some implementations a glitch intervention tactic can be used wherein the AI system generates a flaw in an audio signal playing on a device.

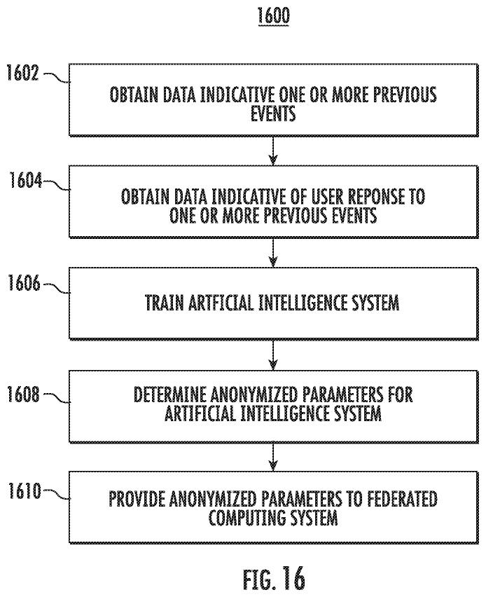

Referring now to FIG. 16, a flow diagram of an example method 1600 of training an AI system is depicted. Although FIG. 16 depicts steps performed in a particular order for purposes of illustration and discussion, the methods of the present disclosure are not limited to the particularly illustrated order or arrangement. The various steps of the method 1600 can be omitted, rearranged, combined, and/or adapted in various ways without deviating from the scope of the present disclosure.

At 1602, the method can include obtaining data indicative of one or more previous events. For example, the one or more previous events can include communications to the user received by a computing system (e.g., text messages, SMS messages, voice messages, etc.). In some implementations, the one or more events can include external audio signals received by the computing system, such as audio signals associated with the surrounding environment (e.g., PA announcements, verbal communications, etc.). In some implementations, the one or more events can include notifications from applications operating on the computing system (e.g., application badges, news updates, social media updates, etc.). In some implementations, the one or more events can include prompts from an application operating on the computing system (e.g., calendar reminders, navigation prompts, phone rings, etc.). In some implementations, the data indicative of one or more previous events can be included in a training dataset generated by the AI system.

At 1604, the method can include obtaining data indicative of a user response to the one or more previous events. For example, the data indicative of the user response can include one or more previous user interactions with a computing system in response to the one or more previous events. For example, whether a user viewed a news article from a news application notification can be used to train whether to provide similar news updates in the future. In some implementations, the data indicative of the user response can include one or more previous user inputs descriptive of an intervention preference received in response to the one or more previous events. For example, an AI system can inquire as to whether the user would like to receive similar content in the future. In some implementations, the data indicative of a user response can be included in a training dataset generated by the AI system.

At 1606, the method can include training an AI system comprising one or more machine-learned models to incorporate an audio signal associated with one or more future events into an acoustic environment of a user based at least in part on the semantic content for the one or more previous events associated with the user and the data indicative of the user response to the one or more events. For example, the AI system can be trained to incorporate audio signals into an acoustic environment in a way similar to how the user responds to similar events or to better align with a user's stated preference.

At 1608, the method can include determining one or more anonymized parameters associated with the AI system. For example, the AI system can be a local AI system stored on a user's personal device. The one or more anonymized parameters can include, for example, one or more anonymized parameters for the one or more machine-learned models of the AI system.

At 1610, the method can include providing the one or more anonymized parameters associated with the AI system to a server computing system configured to determine a global AI system based at least in part on the one or more anonymized parameters via federated learning. For example, the server computing system can receive a plurality of local AI system anonymized parameters and can generate a global AI system. For example, the global AI system can be used to initialize an AI system on a user's device.

The technology discussed herein makes reference to servers, databases, software applications, and other computer-based systems, as well as actions taken and information sent to and from such systems. The inherent flexibility of computer-based systems allows for a great variety of possible configurations, combinations, and divisions of tasks and functionality between and among components. For instance, server processes discussed herein may be implemented using a single server or multiple servers working in combination. Databases and applications may be implemented on a single system or distributed across multiple systems. Distributed components may operate sequentially or in parallel.

While the present subject matter has been described in detail with respect to specific example embodiments and methods thereof, it will be appreciated that those skilled in the art, upon attaining an understanding of the foregoing may readily produce alterations to, variations of, and equivalents to such embodiments. Accordingly, the scope of the present disclosure is by way of example rather than by way of limitation, and the subject disclosure does not preclude inclusion of such modifications, variations and/or additions to the present subject matter as would be readily apparent to one of ordinary skill in the art.

Further, although the present disclosure is generally discussed with reference to computing devices, such as smartphones, the present disclosure is also applicable to other forms of computing devices as well, including, for example, laptop computing devices, tablet computing devices, wearable computing devices, desktop computing devices, mobile computing device, or other computing devices.

1. A method for generating an audio presentation for a user, comprising:
obtaining, by a portable user device comprising one or more processors, data indicative of an acoustic environment of the user, the acoustic environment of the user comprising at least one of a first audio signal playing on the portable user device or a second audio signal associated with a surrounding environment of a user that is detected via one or more microphones that form part of, or are communicatively coupled with, the portable user device;
obtaining, by the portable user device, data indicative of one or more events, the one or more events comprising at least one of information to be conveyed by the portable user device to the user or at least a portion of the second audio signal associated with the surrounding environment of the user;
generating, by an on-device artificial intelligence system of the portable user device, an audio presentation for the user based at least in part on the data indicative of the one or more events and the data indicative of the acoustic environment of the user, wherein generating the audio presentation comprises determining a particular time to incorporate a third audio signal associated with the one or more events into the acoustic environment; and
presenting, by portable user device, the audio presentation to the user.

2. The method of claim 1, wherein the audio presentation is presented to the user via one or more wearable speaker devices, and optionally wherein:
the first audio signal is being played to the user via the one or more head mounted speaker devices and/or at least one of the one or more microphones form part of the one or more head mounted speaker devices.

3. The method of claim 1 wherein the one or more wearable speaker devices comprise one or more head-mounted wearable speaker devices.

4. (canceled) A method for generating an audio presentation for a user, comprising:
obtaining, by a computing system comprising one or more processors, data indicative of an acoustic environment for the user, the acoustic environment for the user comprising at least one of a first audio signal playing on the computing system or a second audio signal associated with a surrounding environment of a user;
obtaining, by the computing system, data indicative of one or more events, the one or more events comprising at least one of information to be conveyed by the computing system to the user or at least a portion of the second audio signal associated with the surrounding environment of the user;
generating, by an artificial intelligence system via the computing system, an audio presentation for the user based at least in part on the data indicative of the one or more events and the data indicative of the acoustic environment for the user; and
presenting, by the computing system, the audio presentation to the user;
wherein generating, by the artificial intelligence system, the audio presentation comprises determining, by the artificial intelligence system, a particular time to incorporate a third audio signal associated with the one or more events into the acoustic environment.

5. The method of claim 4 wherein determining, by the artificial intelligence system, the particular time to incorporate the third audio signal associated with the one or more events into the acoustic environment comprises:
identifying a lull in the acoustic environment; and
selecting the lull as the particular time.

6. The method of claim 4 wherein determining, by the artificial intelligence system, the particular time to incorporate the third audio signal associated with the one or more events into the acoustic environment comprises:
determining, by the artificial intelligence system, an urgency of the one or more events based at least in part on at least one of a geographic location of the user, a source associated with the one or more events, or semantic content of the data indicative of the one more events, and
determining, by the artificial intelligence system, the particular time based at least in part on the urgency of the one or more events

7. The method of claim 4, wherein the third audio signal is associated with a first event of the one or more events and wherein the method further comprises:
determining, by the artificial intelligence system, to not incorporate an audio signal associated with a second event of the one or more events into the acoustic environment.

8. The method of claim 4, wherein obtaining the data indicative of the acoustic environment for the user comprises obtaining the second audio signal associated with a surrounding environment of the user; and
wherein generating, by the artificial intelligence system, the audio presentation for the user comprises noise-cancelling at least a portion of the second audio signal associated with the surrounding environment of the user.

9. The method of claim 4, wherein generating, by the artificial intelligence system, the audio presentation further comprises incorporating, by the artificial intelligence system, the third audio signal into the acoustic environment at the particular time.

10. The method of claim 4, wherein generating, by the artificial intelligence system, the audio presentation further comprises:
generating, by the artificial intelligence system, the third audio signal based at least in part on the data indicative of the one or more events.

11. The method of claim 4, wherein generating, by the artificial intelligence system, the third audio signal based at least in part on the data indicative of the one or more events comprises generating, by the artificial intelligence system, the third audio signal based at least in part on a semantic content of the data indicative of one or more events.

12. The method of claim 4, wherein generating, by the artificial intelligence system, the third audio signal based at least in part on the semantic content of the one or more events comprises summarizing the semantic content of the one or more events.

13. The method of claim 4, wherein the one or more events comprise at least one of a communication to the user received by the computing system, an external audio signal received by the computing system comprising at least a portion of the second audio signal associated with the surrounding environment of the user, a notification from an application operating on the computing system, or a prompt from an application operating on the computing system.

14. The method of claim 4, wherein incorporating the third audio signal into the acoustic environment comprises at least one of incorporating the third audio signal into the acoustic environment using at least one intervention tactic; and
wherein the at least one intervention tactic comprises at least one of: interrupting the first audio signal, filtering the first audio signal, holding and continuously playing a first portion of the first audio signal by stretching the first portion of the first audio signal, holding and repeatedly playing a second portion of the first audio signal by repeatedly looping the second portion of first audio signal, changing a perceived direction of the first audio signal, overlaying the third audio signal onto the first audio signal, lowering a volume of the first audio signal, or generating a flaw in the first audio signal.

15. The method of claim 4, wherein determining, by the artificial intelligence system, the particular time to incorporate the third audio signal associated with the one or more events into the acoustic environment comprises determining, by the artificial intelligence system, to not incorporate the third audio signal into the acoustic environment.

16. The method of claim 4, wherein the audio presentation is generated based at least in part on a user input descriptive of a listening environment.

17. The method of claim 4, wherein the artificial intelligence system has been trained based at least in part on a previous user input descriptive of an intervention preference.

18. The method of claim 4, wherein the artificial intelligence system has been trained based at least in part on one or more previous user interactions with the computing system in response to one or more previous events.

19. A method of training an artificial intelligence system, the artificial intelligence system comprising one or more machine-learned models, the artificial intelligence system configured to generate an audio presentation for a user by receiving data of one or more events and incorporating a first audio signal associated with the one or more events into an acoustic environment of the user, the method comprising:
obtaining, by a computing system comprising one or more processors, data indicative of one or more previous events associated with a user, the data indicative of the one or more previous events comprising semantic content for the one or more previous events;
obtaining, by the computing system, data indicative of a user response to the one or more previous events, the data indicative of the user response comprising at least one of one or more previous user interactions with the computing system in response to the one or more previous events or one or more previous user inputs descriptive of an intervention preference received in response to the one or more previous events; and
training, by the computing system, the artificial intelligence system comprising the one or more machine-learned models to incorporate an audio signal associated with one or more future events into an acoustic environment of the user based at least in part on the semantic content for the one or more previous events associated with the user and the data indicative of the user response to the one or more events;
wherein the artificial intelligence system comprises a local artificial intelligence system associated with the user.

20. The method of claim 19, further comprising:
receiving, by the computing system, at least one of data indicative of a user location for the one or more previous events or data indicative of a source of the one or more previous events; and
wherein training, by the computing system, the artificial intelligence system comprises training, by the computing system, the artificial intelligence system based at least in part on at least one of the data indicative of the user location for the one or more previous events or the data indicative of the source for the one or more previous events.

21. The method of claim 19, further comprising:
determining, by the computing system, one or more anonymized parameters associated with the local artificial intelligence system associated with the user;
providing, by the computing system, the one or more anonymized parameters associated with the local artificial intelligence system associated with the user to a server computing system configured to determine a global artificial intelligence system based at least in part on the one or more anonymized parameters via federated learning.

22. A system, comprising:
an artificial intelligence system that comprises one or more machine-learned models;
one or more processors; and
one or more non-transitory computer-readable media that collectively store instructions that when executed by the one or more processors cause the computing system to perform operations, the operations comprising:
obtaining data indicative of an acoustic environment for the user, the acoustic environment for the user comprising at least one of a first audio signal playing on the computing system or a second audio signal associated with a surrounding environment of the user;
obtaining, data indicative of one or more events, the one or more events comprising at least one of information to be conveyed by the computing system to the user or at least a portion of the second audio signal associated with the surrounding environment of the user;
generating, by the artificial intelligence system, an audio presentation for the user based at least in part on the data indicative of the one or more events and the data indicative of the acoustic environment for the user; and
presenting the audio presentation to the user;
wherein generating, by the artificial intelligence system, the audio comprises:
determining a particular time to incorporate a third audio signal associated with the one or more events into the acoustic environment; and
incorporating the third audio signal into the acoustic environment at the particular time.

23. The system of claim 22, wherein generating, by the artificial intelligence system, the audio comprises generating the third audio signal based at least in part on a semantic content of the one or more events.

24. The system of claim 22, wherein the system further comprises a wearable device comprising a speaker; and
wherein presenting the audio presentation to the user to the user comprises playing the audio presentation via the wearable device.

25. (canceled)

26. (canceled)
